(19) United States
(12) Patent Application Publication
(10) Pub. No.: US 2019/0197887 A1
(43) Pub. Date: Jun. 27, 2019

(54) COORDINATED ALERT AND EVENT GUIDANCE SYSTEM

(71) Applicant: Echelon Corporation, Santa Clara, CA (US)

(72) Inventors: Sohrab MODI, Oakland, CA (US); John G. WACLAWSKY, Alpine, WY (US)

(73) Assignee: Echelon Corporation, Santa Clara, CA (US)

(21) Appl. No.: 15/851,929

(22) Filed: Dec. 22, 2017

(51) Int. Cl. G08G 1/01; H04B 10/50; G08G 1/04; H04B 10/548; G08G 1/08; G08G 1/005; G08G 1/0967

(52) U.S. Cl. CPC G08G 1/0145; H04B 10/502; G08G 1/04; H04B 10/548; G06K 9/00785; G08G 1/0133; G08G 1/005; G08G 1/0967; G08G 1/08

(57) ABSTRACT

A system for providing an optical event alert signal to portable devices carried by pedestrians or vehicles, comprises: a video unit located along a thoroughfare, configured to capture sound, and video images of traffic conditions and events, analyze and recognize types of events, and transmit one or more identified event data packets over a communication link to lighting device nodes located around or along the thoroughfare; and one or more lighting device nodes located along a thoroughfare, configured to repeat and cascade event information using propagation control and decode the identified event data packets and modulate an LED array to transmit an optical event signal to portable devices carried by pedestrians and vehicles.

### FIELD OF THE INVENTION

The invention disclosed broadly relates to distributing optical event signals to sensors and portable devices carried by pedestrians and vehicles in vehicular traffic. Events can be alerts or information relayed and cascaded optically by lights, including displays, or by radio, to spread knowledge of the event from the source. The event can be repeated by lighting fixtures or signs along a roadway for any defined distance or length of time guided by event characteristic or severity,

### BACKGROUND OF THE INVENTION

What is needed is a low cost way to distribute traffic and public safety events to sensors and portable devices carried by pedestrians and vehicles in vehicular traffic. In addition, propagation control is necessary to control the duration and spread of event information needed to restrict or meter traffic to an area, divert oncoming traffic and prevent cross traffic from turning into a congested, accident or problem area. Even traffic signal duration can be adjusted to favor traffic heading away from a congested or accident area.

### SUMMARY OF THE INVENTION

In accordance with an example embodiment of the invention, a video unit located along a thoroughfare captures video images of traffic conditions, safety issues such as road conditions (such pot holes) and events (such as accidents and construction activity). The video unit analyzes and recognizes types of events, and transmits one or more identified event data packets over radio or optical communication links to lighting device nodes located along or lining the thoroughfare. The lighting device nodes decode the identified event data packets and modulates an LED array to transmit an optical event alert signal to sensors, such as GPS, and portable devices such as mobile devices with cameras and sensors carried by pedestrians and vehicles. Each lighting device node can relay and cascade the event data packets to further out intersecting thoroughfares to divert traffic or warn them against turning into a problem or restricted area.

The video unit located at the thoroughfare, includes a video camera, video frame processing logic, a processor and memory including computer program code. The video unit is configured to cause the video frame processing logic to process a video stream from the video camera while monitoring the traffic conditions and events at the thoroughfare. The video unit is configured to identify a traffic event associated with the thoroughfare and surrounding area, to analyze the traffic event, and to encode traffic meta data characterizing the analysis of the traffic event. The video unit includes a communications unit configured to transmit the meta data characterizing analysis of the traffic event to lighting device nodes. The meta data can also include fields to indicate the severity of the problem along with propagation control fields that includes GPS coordinates of the event and range information, called a GPS limit field, so that lighting nodes will not propagate the event information any further to out of range devices. Optionally, for non-GPS devices, a distance field can be used to increment or decrement a count that represents a point to terminate the cascade and relay activity of the lighting devices. Also optionally, a time field can be added to the meta data to indicate a duration after which the event information will become stale if no other event messages are received. This prevents intermittently or recently disconnected lighting nodes from distributing old and no longer useful event information. Traffic signals can use this information to adjust traffic flow by extending the duration of egress from a traffic intersection for vehicles moving away from a problem area. This will minimize the possibility of grid-lock. In addition event information can be used by traffic signals to meter traffic into congested areas.

The lighting device node decodes the identified event data packets and modulates an LED array to transmit an optical event alert signal to sensors and portable devices carried by pedestrians and vehicles. The lighting device node is configured to modulate illumination level of the LED array or modulate color of the LED array. The lighting node adjusts the distance field for non-GPS devices and subsequently uses this information, or GPS limit field information, as guidance to propagate the event information or terminate the relay and cascade function.

### DESCRIPTION OF THE FIGURES

FIG. 1 illustrates an example embodiment of the invention, wherein a video unit located along a thoroughfare captures video images of traffic conditions and events. The video unit analyzes and recognizes types of events, and transmits one or more identified event data packets over radio or optical communication links to nearby lighting device nodes located along the thoroughfare. The lighting device nodes decode the identified event data packets and modulate an LED array to transmit an optical event alert signal to portable receivers carried by pedestrians and vehicles. The lighting node adjusts the distance field, and makes a determination to continue with relaying and cascading the event information by using either GPS limit information or non-GPS means. Even though a lighting node has GPS that doesn't mean that the next node in the relay has it. So the distance field must always be adjusted by each lighting node.

FIG. 2 illustrates an example embodiment of the invention, showing the video unit 102 located at the thoroughfare, including a video camera, video frame processing logic, a processor and memory including computer program code. The video unit is configured to cause the video frame processing logic to process a video stream from the video camera while monitoring the traffic conditions and events at the thoroughfare. The video unit is configured to identify a traffic event associated with the thoroughfare or street intersection (such as an accident, delivery truck, police or ambulance blocking a right of way), to analyze the traffic event, and to encode traffic meta data characterizing the analysis of the traffic event along with GPS coordinates (and an initial propagation control distance field usable for non-GPS devices). The video unit includes a communications unit configured to transmit the meta data characterizing analysis of the traffic event and propagation control information to the lighting device nodes.

FIG. 3 illustrates an example embodiment of the invention, showing an example functional block diagram of the lighting device node N1. The lighting device node decodes the identified event data packets and modulates an LED array to transmit an optical event alert signal to portable receivers carried by pedestrians and vehicles. The lighting device node also relays and cascades the event information, if appropriate, using the same optical communication link 107 or through an additional radio link to the next lighting device node (this radio link not shown in FIG. 3).

FIG. 4A illustrates an example of a street grid with a traffic accident event observed by the video unit located along the street, the video unit capturing video images of the event, analyzing the images, and transmits event information, either optically or by radio, to lighting device nodes located nearby which, in turn relay and cascade the event information farther along the streets surrounding the location of the accident.

FIG. 4B illustrates an example of the street grid of FIG. 4A, showing traffic lights responding to event information to either allow traffic priority to leave a congested area, prevent traffic from proceeding to or turning into a congested area, or used to meter traffic into a congested area.

### DISCUSSION OF THE PREFERRED EMBODIMENTS

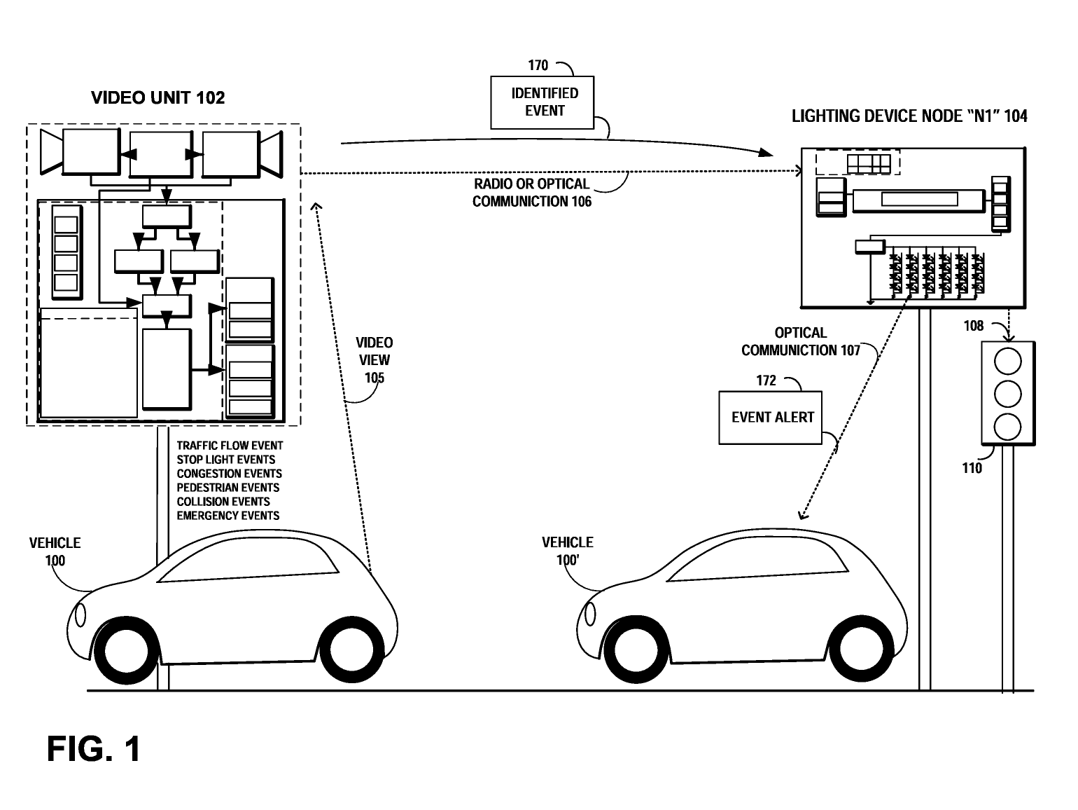

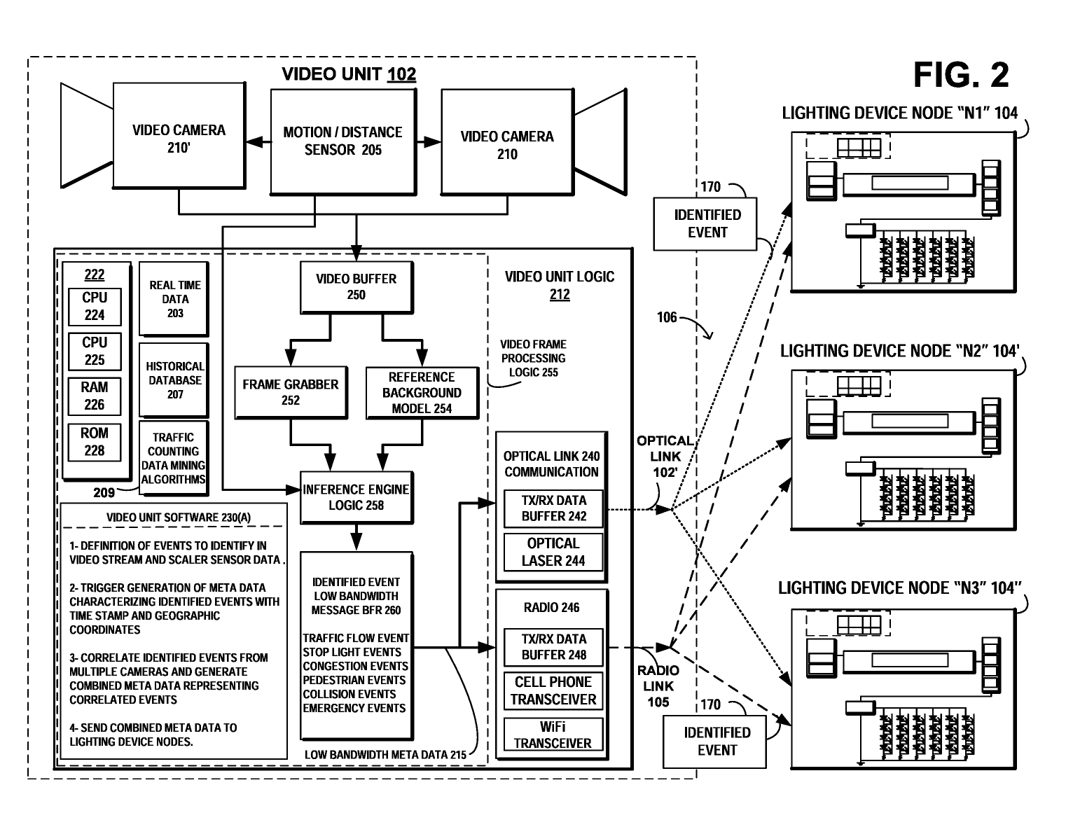

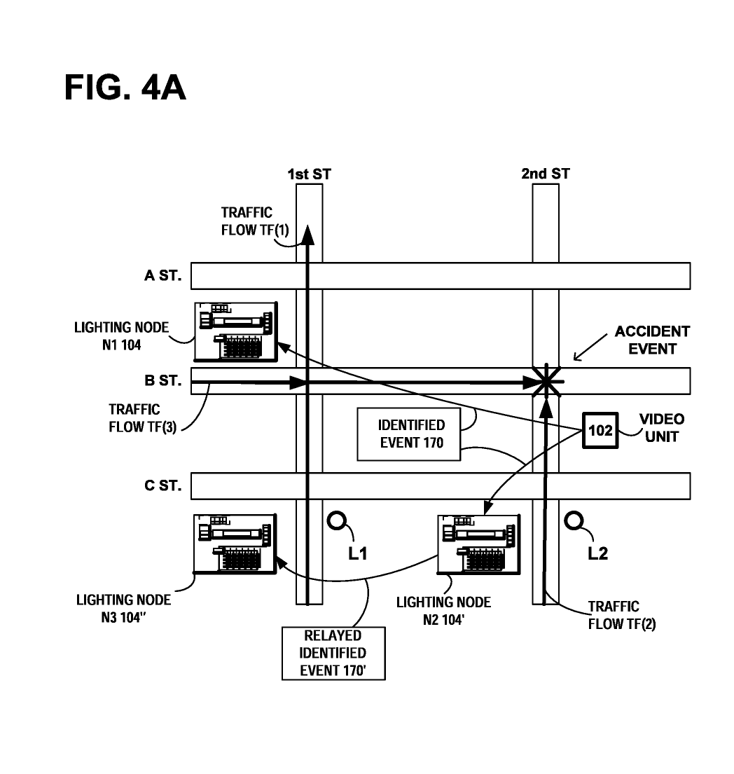

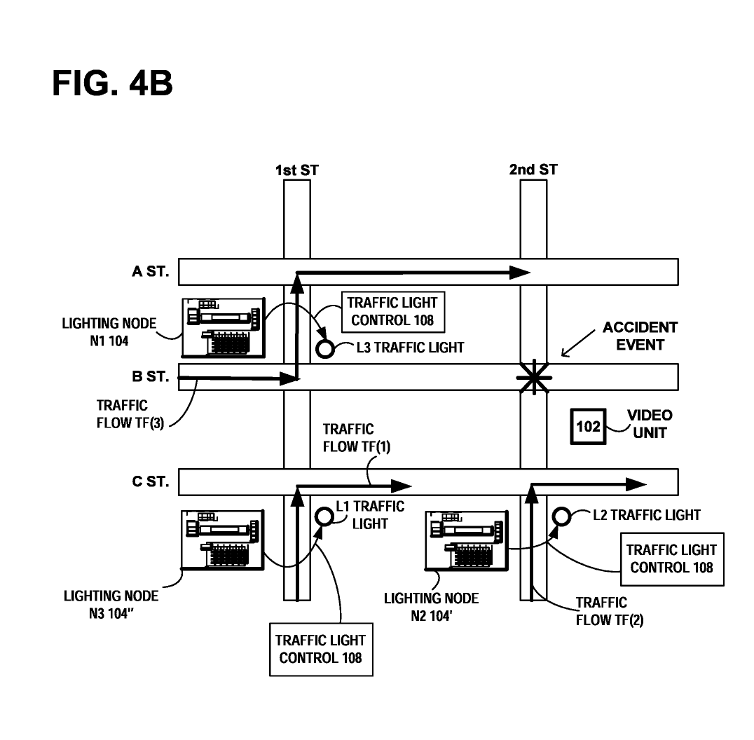

FIG. 1 illustrates an example embodiment of the invention, wherein a video unit 102 located along a thoroughfare captures video images 105 of traffic conditions and events occurring with the vehicle 100. The video unit 102 analyzes and recognizes types of events, such as: traffic flow event, stop light events, congestion events, pedestrian events, collision events, and emergency events. The video unit 102 transmits one or more identified event data packets 170 over radio or optical communication links 106 to surrounding lighting device nodes (shown in the street map as 104, 104′ and 104″ in FIGS. 2, 4A and 4B). An example of a lighting device node is shown as 104 in FIG. 1 located along the thoroughfare. The lighting device node 104 decodes the identified event data packets 170 and modulates an LED array to transmit an optical event alert signal 172 to portable devices carried by pedestrians and the vehicle 100′. Optical frequency mapping may be used to modulate the light 107 from the lighting node 104, which can be decoded by vehicles 100′ having cameras or sensors to receive the frequency modulated message 172. The frequency mapping may be using specific frequencies to provide a priority scale for different classes of event messages: F(x)=Highest, F(x−1) next highest . . . F(x−n)=lowest. The frequencies may be a simple three level scale consisting of red, green or blue.

In addition, the lighting device node 104 inspects the propagation control fields in event alert message 170 to determine if the event information needs to be further propagated via radio or optically.

In an example application of the invention, the vehicle 100 located near the video unit 102 has been involved in a traffic accident. In response, the video unit 102 analyzes and recognizes the non-moving vehicle, and may have even recorded the sound of a crash that may be used to further verify a crash occurred. Subsequently, the traffic accident event is transmitted using one or more identified event data packets 170 over radio or optical communication links 106 to surrounding lighting device nodes 104. In turn node 104 may relay and cascade event information from the accident area by embedding the identified event packet into its lighting so that any additional lighting node devices that may see the modulated light from 104 will receive and decode the event information. The lighting device node 104 decodes the identified event data packets 170 and modulates the LED array to transmit an optical event alert signal 172 to portable devices carried by pedestrians and the vehicle 100′. Optionally multiple event communication messages may be used. For example, event type 170 and 172, shown in FIG. 1, may be different. Event type 170 may be used strictly for information propagation between fixed objects, such as between lighting node devices and to traffic signals and intelligent signage while event type 172 may be used for event information to be transmitted to only moving objects, such as pedestrian and vehicular traffic. Optionally, a specific light frequency may be used to assign a priority to any of the communication messages. In addition these same message may be transmitted by radio or IR means.

In an example embodiment of the invention, the lighting device node 104 may communicate with traffic lights 110 by means of optical or radio link 108, in responding to event information received in identified event data packets 170, to either allow traffic priority to pedestrians or vehicles leaving a congested area, or to prevent traffic from proceeding to or turning into a congested area, or used to meter traffic into a congested or restricted area.

FIG. 2 illustrates an example embodiment of the invention, showing the video unit 102 located at the thoroughfare. The video unit 102 includes a pair of video cameras 210 and 210′. Video unit logic 212 includes video frame processing logic 255, a processor and memory 222 including computer program code. The video unit 102 is configured to cause the video frame processing logic 255 to process a video stream from the video camera 210/210′ while monitoring the traffic conditions and events at the thoroughfare. The video unit 102 is configured to identify a traffic event associated with the thoroughfare and surrounding areas, to analyze the traffic event and assess its severity, and to encode traffic meta data characterizing the analysis of the traffic event including the GPS coordinates of the event. The video unit may modify propagation control field to align with the severity of the event. This alignment can be programmable and defined via existing network connections from a management platform. This alignment allows more severe events to propagate further to better adjust traffic flows when a major event, such as a fire, makes ingress into an area all but impossible. The video unit 102 includes a communications unit 240 and 246 configured to transmit the meta data characterizing analysis of the identified event 170 to the lighting device nodes 104, 104′, and 104″ along the thoroughfare. Those lighting devices, street lights or intelligent signage that are out of range of the video unit 102 will get relayed or propagated event information from lighting device nodes 104, 104′ and 104″. The identified event data packets 170 may include meta data with a GPS coordinate data field, GPS distance limit field, and non-GPS data field containing a count that is incremented or decremented to a value used to decide if the relay and propagation function needs to be terminated.

The video frame processing logic 255 comprises a video buffer 250, frame grabber 252, reference background model 254, and inference engine logic 258. The video unit also includes analysis algorithms, which may be the result of pre-programmed deterministic actions or AI driven. The reference background model 254 is a program construct stored in the RAM 226, which is a learned model that looks at background in various lighting, color temperature, shadow and other conditions. The sensor 205 viewing the thoroughfare, senses the approach of a car 100. The video unit 102 is configured to receive a signal from the sensor 205 indicating a traffic event such as the approach of a car, to enable the video unit 102 to capture any identification data requested due to programming such as the number on the license plate of the car, or a windshield or bumper sticker, etc.

The video cameras 210 and 210′ comprise an image sensor plus a 3D sensor, including a red, green, blue (RGB) sensor plus an infrared (IR) sensor and a microphone.

The reference background model 254 includes a traffic learning model, which includes, but is not limited to, multiple reference frame buffers for different light and weather conditions, a model of lighting, a model of shadows, a model of motion, and audio analysis samples used to help determine if a traffic accident has occurred or a siren sound from police or an emergency vehicle has occurred. This determination may simply be noticing a stopped car after an audio spike typical of a crash occurs and used to reinforce video analysis that an accident did indeed occur or public safety vehicles are involved.

For example, the model of light and weather conditions takes as an input, the current time of day and the level of solar illumination on cloudy versus sunny days. The light and weather model correlates, over time, the background light level illuminating the thoroughfare, based on the time of day and the level of solar illumination. The light and weather model assigns a score to various background light levels. For a current time of day and the level of solar illumination, the light and weather model provides the corresponding score to the inference engine, as one of the factors used by the inference engine in determining the occurrence of reportable event being monitored.

The video frame processing logic 255 processes the video stream from the video camera 210 while monitoring a thoroughfare and surrounding area, to identify an event. The video unit 102 also includes a motion/distance sensor 205 that senses the motion and distance of objects, such as moving a car in the thoroughfare 100 and triggers the video camera 210 to turn on or start recording. The motion/distance sensor 205 inputs event signals for detected motion and distance to the inference engine logic 258. The microphone may be turned by the motion sensor or when the video camera is activated or at any time during this process.

The inference engine logic 258 comprises an inference engine, which includes, but is not limited to, multiple classifiers. Examples of classifiers are: 1. traffic state classifier; 2. traffic violation classifier; 3. parking violation classifier; 4. Suspected activity classifier; and 5. Collision classifier. The inference engine logic 258 is a program construct stored in the RAM 226. The inference engine logic 258 outputs traffic meta data that identifies a traffic event associated with the thoroughfare. The inference engine logic 258 analyzes the traffic event and to encodes traffic meta data characterizing the analysis of the traffic event. Examples of meta data output by the inference engine logic 258 includes the following:
number of vehicles
time stamps
location (GPS coordinates, address, etc.)
classification (car motorcycle, bus, truck, limo etc.)
lane occupancy
flow per lane
speed of each object (car, truck etc.)
average speed—collect information on the average speed of vehicles passing through a road way (separated by vehicle classification type if required).
color search—perform an color based search of people or vehicles, to quickly find suspicious objects after an event has occurred.
exportable CSV—Export event information, including vehicle speeds, counts, and classification data, to share with partners or ingest into other tools.
no exit—detect if a car has parked and no one has left the vehicle. This is useful to detect suspicious activity
pedestrian activity—detect when pedestrians are too close to the roadway or gathering on the side of the road.
pedestrian crosswalk safety and counting—count pedestrians as they walk along sidewalks or crosswalks, ensure pedestrian safety, or detect when people jaywalk, etc.
person/vehicle classification—effortlessly set up classification to detect between people and vehicles, and then more closely classify between vehicle types—cars, trucks, motorcycles, and more.
information to mark the start date of videos being processed, and assign specific time periods to events based on the video start date/time.
smoke/fire detection—visually detect if a fire has occurred in the monitored through-fare area. standard smoke and fire detectors do not work well outdoors, our visual detector will notify you right away.
speeding vehicle—detect and provide information about vehicles speeding through traffic scenes. Speeding vehicles are unsafe, but can be hard to catch.
stopped vehicle—detect a vehicle idling in a suspicious location, whether they have broken down or are illegally parked.
track summaries—after-the-fact review track summaries and snapshots of people or vehicles as they move through the scene. Search for tracks based on location, color, and classification to effortlessly go through processed video, without needing to re-process.
traffic heat map—generate a heat map to see an overview of traffic information and provide intuitive demonstration tools for presentations (heat map: a graphical representation of data where the individual values contained in a matrix are represented as colors)
turn count—count vehicles following specific tracks through the roadway. Differentiate the counts between where vehicles came from and where they turned.
vehicle classification: truck, car, motorcycle—Quickly and easily classify between vehicle types, including truck, motorcycle, car, and more. Use this classification information in each of the other event types, including speed, counting, idling objects, and more
wrong way—detect vehicles or people going against the flow of traffic.

The video unit 102 is configured to encode a low bandwidth message 170 characterizing the event. The video unit 102 includes an optical link communications unit 240 that includes a transmit/receive (TX/RX) buffer 242 and optical laser 244 configured to transmit the low bandwidth message 170. In an alternate embodiment, the video unit 102 includes a radio unit 246 that includes a transmit/receive (TX/RX) buffer 248, a cell phone transceiver, and a WiFi transceiver, which are configured to transmit the low bandwidth message 170.

The video unit 102 includes a processor 222 comprising a dual central processor unit (CPU) or multi-CPU 224/225, a random access memory (RAM) 226 and read only memory (ROM) 228. The memories 226 and/or 228 include computer program code, including video unit software 230(A) and storage for analysis algorithms. The identified event low bandwidth message buffer 260 may include example meta data messages 215, such as: traffic flow event, stop light events, congestion events, pedestrian events, collision events, and emergency events.

The video unit software 230(A) includes analysis algorithms and example instructions such as the following:
1—definition of events to identify in video stream and scalar sensor data including microphone captured data.
2—trigger generation of meta data characterizing identified events with time stamp and geographic coordinates
3—correlate identified events from multiple cameras and generate combined meta data representing correlated events with a severity assessment, GPS coordinates and propagation range to be inspected by GPS and distance field to be inspected non-GPS lighting device nodes and modified if relayed or cascaded.
4—send meta data to lighting device nodes 104, 104′, and 104″.

The example embodiment of the invention has the advantage of working over restrictive low bandwidth communication links, however it is not restricted to low bandwidth and works over higher bandwidth communication links.

The one or more identified event data packets 170 may be transmitted by video unit 102 over the communication link 106 to lighting device nodes 104, 104′, and/or 104″ located around or along the thoroughfare. Further propagation of the event information is based on geo-locations of the lighting device nodes. For non-GPS devices a distance field may be utilized.

The one or more identified event data packets 170 may be transmitted by video unit 102 over the communication link 106 to lighting device nodes 104, 104′, and/or 104″ located around or along the thoroughfare, based on severity of the event, wherein identified event data packets for more serious events propagate out further than for less serious events.

The one or more identified event data packets 170 may be transmitted by video unit 102 over the communication link 106 to lighting device nodes 104, 104′, and/or 104″ located around or along the thoroughfare, based on traffic congestion control of traffic lights, using traffic congestion events to re-route traffic around or meter traffic into a congested area.

The one or more identified event data packets 170 may be transmitted by video unit 102 over the communication link 106 to lighting device nodes 104, 104′, and/or 104″ located around or along the thoroughfare, based on traffic congestion control to avoid grid-lock.

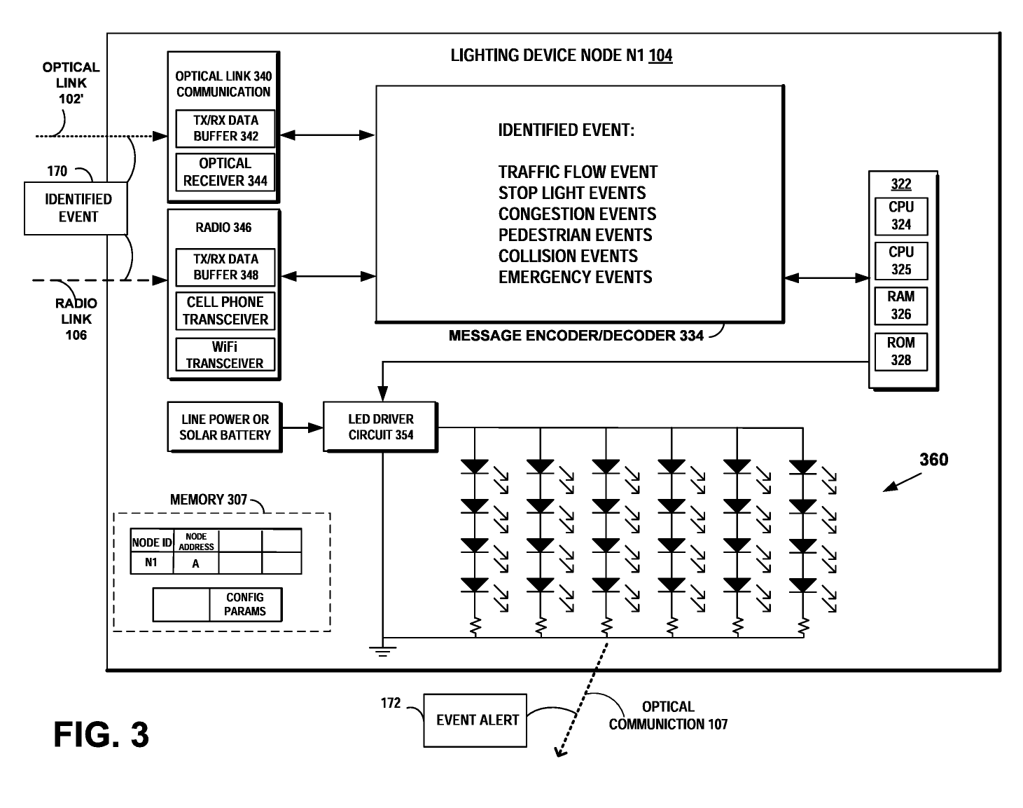

FIG. 3 illustrates an example embodiment of the invention, showing an example functional block diagram of the lighting device node N1 104. The lighting device node 104 decodes the identified event data packets 170 and modulates an LED array 360 to transmit an optical event alert signal 172 to portable devices carried by pedestrians and vehicles 100′. Optionally, specific lighting frequencies may be used to indicate relative priority of the event. The lighting device node 104 also determines if it needs to propagate the event information to other lighting nodes by inspecting the propagation fields of identified event packet 170 to use either the GPS coordinates along with the distance limit field or the distance count field to make that decision.

Lighting device node Process: 1) receive identified event and determine if it is GPS or non-GPS capable. 2) Use appropriate propagation control field to decide if event information is to be repeated and cascaded. 3) adjust distance field for non-GPS device nodes downstream if event is repeated or cascaded. 4) repeat and cascade the event information if necessary 5) communicate with pedestrians and vehicles 107.

The example lighting device N1 shown in FIG. 3, includes an optical link communications unit 340 that includes a transmit/receive (TX/RX) buffer 342, which is configured to communicate with the video unit 102 via optical link 102′ or radio link 106. The device N1 104 activates the LED driver circuit 354 controlled by the processor 322, to power the LED light array 360 with either line power, battery power, or photovoltaic solar power. Depending on the control parameters in the identified event packet 170, the light array 360 may be turned on, its illumination level modulated, its color modulated or frequency adjusted through color selection (including just using 3 colors, either red, green or blue), or turned off, in response. The LED driver circuit 354 controls the voltage and current patterns sent to each LED element (Red, Green, Blue) in the LED array 360. The LED array 360 may be a single light fixture with a plurality of Red, Green and Blue LEDs contained in the light fixture, or it may be an array of LED's.

The example lighting device N1 104 includes a processor 322 comprising a dual central processor unit (CPU) or multi-CPU 324/325, a random access memory (RAM) 326 and read only memory (ROM) 328. The memories 326 and/or 328 include computer program code for responding to lighting control information messages 170 from the central management system 101.

FIG. 4A illustrates an example of a street grid with a traffic accident event observed by the video unit 102 located along B Street. The video unit 102 captures audio or video images or both of the event at the intersection of B Street and 2^{nd} Street. The video unit 102 analyzes the images, along with any available audio, and transmits one or more identified event data packets 170 with the event information to nearby lighting device nodes N1 104 and N2 104′. Lighting device node N1 104 is located at the intersection of B Street and 1^{st} Street and lighting device node N2 104′ is located at the intersection of C Street and 2^{nd} Street. Lighting device node N2 104′ is shown relaying the identified event data packet 170′ to the lighting device node N3 104″ located at the intersection of C Street and 1^{st} Street.

FIG. 4B illustrates an example of the street grid of FIG. 4A, showing traffic lights L1, L2, and L3 responding to the traffic accident event information distributed in FIG. 4A, to either allow traffic priority to leave a congested area, prevent traffic from proceeding to or turning into a congested area, or used to meter traffic into a congested area. Traffic lights and intelligent signage may be set up so the traffic lights and intelligent signage can independently receive event information 170 shown in FIG. 4B and make traffic flow modification decisions on their own. Intersections with multiple traffic lights and intelligent signage may need to be coordinated. This means that, optionally, traffic lights and intelligent signage may be controlled by a nearby street light which has all the processing logic and makes coordinated traffic flow decisions for a complex intersection with multiple traffic lights and intelligent signage. This is shown by example in FIG. 4B with lighting device node N1 104 sending traffic light control 108 to traffic light L3 to divert the traffic flow TF(3) off of B Street. Lighting device node N2 104′ sends traffic light control 108 to traffic light L2 to divert the traffic flow TF(2) off of 2^{nd} Street. Lighting device node N3 104″ sends traffic light control 108 to traffic light L1 to divert the traffic flow TF(1) off of 1^{st} Street. If multiple traffic lights and intelligent signage were present at these intersections they may would be similarly controlled by the street lights.

The resulting invention captures audio (optionally) and video images of traffic conditions and events. The video unit analyzes and recognizes types of events, and transmits one or more identified event data packets over radio or optical communication links to lighting device nodes located along the thoroughfare. The lighting device nodes decode the identified event data packets and modulate an LED array to transmit an optical event alert signal to portable devices carried by pedestrians and vehicles. The lighting node devices also decide if it is necessary to relay or cascade the event information further.

Although specific example embodiments of the invention have been disclosed, persons of skill in the art will appreciate that changes may be made to the details described for the specific example embodiments, without departing from the spirit and the scope of the invention.

What is claimed is:

1. A system for providing an optical event alert signal to portable receivers carried by pedestrians or vehicles, comprising:
a video unit located along a thoroughfare, configured to capture video images of traffic conditions and events, analyze and recognize types of events, and transmit one or more identified event data packets over a communication link to lighting device nodes located around or along the thoroughfare; and
one or more lighting device nodes located around or along a thoroughfare, configured to decode the identified event data packets and modulate an LED array to transmit an optical event alert signal to portable receivers carried by pedestrians and vehicles.

2. The system of claim 1, wherein the video unit further comprises:
a video camera, video frame processing logic, a processor and memory including computer program code;
the video unit configured to cause the video frame processing logic to process a video stream from the video camera while monitoring the traffic conditions and events at the thoroughfare;
the video unit further configured to identify a traffic event associated with the thoroughfare, to analyze the traffic event, and to encode traffic meta data characterizing the analysis of the traffic event; and
the video unit further configured to transmit the meta data characterizing analysis of the traffic event to the one or more lighting device nodes.

3. The system of claim 1, wherein the one or more lighting device nodes are configured to decode the identified event data packets and modulate the LED array to transmit an optical event alert signal to portable receivers carried by pedestrians or vehicles.

4. The system of claim 3, wherein the one or more lighting device nodes are configured to modulate illumination level of the LED array or modulate color of the LED array.

5. The system of claim 1, wherein the one or more identified event data packets are transmitted over the communication link to lighting device nodes located along the thoroughfare, based on geo-locations of the lighting device nodes.

6. The system of claim 1, wherein the one or more identified event data packets are transmitted over the communication link to lighting device nodes located along the thoroughfare, based on severity of the event, wherein identified event data packets for more serious events propagate out further than for less serious events.

7. The system of claim 1, wherein the one or more identified event data packets are transmitted over the communication link to lighting device nodes located around or along the thoroughfare, based on traffic congestion control of traffic lights, using traffic congestion events to meter traffic into a congested area.

8. The system of claim 1, wherein the one or more identified event data packets are transmitted over the communication link to lighting device nodes located around or along the thoroughfare, based on traffic congestion control to avoid grid-lock.

9. The system of claim 2, wherein the video unit further comprises:
a reference background model that includes audio analysis samples used by the video unit to determine if a traffic accident has occurred or if an emergency vehicle's siren sound has occurred.

10. The system of claim 1, wherein both a GPS based and a non-GPS based technique are jointly coordinated and used simultaneously to control event propagation.

11. A lighting device node for providing an optical event alert signal to portable receivers carried by pedestrians or vehicles, comprising:
a communications unit in the lighting device node located along a thoroughfare, configured to receive one or more identified event data packets over a communication link from a video unit located along the thoroughfare, the one or more identified event data packets representing captured video images of traffic conditions and events analyzed and recognized by the video unit; and
a decoder in the lighting device node, configured to decode the one or more identified event data packets and modulate an LED array to transmit an optical event alert signal to portable receivers carried by pedestrians and vehicles.

12. The lighting device node of claim 11, wherein the decoder is configured to modulate illumination level of the LED array or modulate color of the LED array.

13. The lighting device node of claim 11, wherein the decoder is configured to modulate optical frequency of the event alert signal to provide a priority scale for different classes of traffic conditions or events indicated in the identified event data packets.
